(19) United States
(12) Patent Application Publication
(10) Pub. No.: US 2022/0207444 A1
(43) Pub. Date: Jun. 30, 2022

(54) IMPLEMENTING PAY-AS-YOU-GO (PAYG) AUTOMATED MACHINE LEARNING AND AI

(71) Applicant: International Business Machines Corporation, Armonk, NY (US)

(72) Inventors: Gregory Bramble, Larchmont, NY (US); Saket Sathe, Mohegan Lake, NY (US); Long Vu, Chappaqua, NY (US); Theodoros Salonidis, Wayne, PA (US); Horst Cornelius Samulowitz, Armonk, NY (US); Jean-François Puget, Saint Raphael (FR)

(21) Appl. No.: 17/137,930

(22) Filed: Dec. 30, 2020

(51) Int. Cl. G06Q 10/06; G06Q 30/02; G06N 5/02

(52) U.S. Cl. CPC G06Q 10/0639; G06N 5/02; G06Q 30/0283

(57) ABSTRACT

A system and method for assessing Pay-As-You-Go (PAYG) Automatic machine learned (AutoML) model pipeline charge to a user on the basis of performance improvement achieved by configuring a model pipeline with performance enhancements relative to a performance obtained by a base model pipeline. The method performs a ranking of pipelines (customized models) based on a user-specified metric (for example, prediction accuracy, run time, F1 score) or combination of metrics. The price for ranked pipelines is specified based on a “surrogate” model where the surrogate model is fit to the base model price and the maximum price for a model. The base model price relates to use of a current cloud resource utilization-based pricing model. The pricing per model pipeline increments on the basis of performance metric(s) in a linear fashion, e.g., using a linear pricing model, or in an exponential fashion, e.g., using a fixed percentage hike price model.

### FIELD

The present invention relates to Automated Machine Learning (AutoML) and cloud computing, and particularly methods and systems for running cloud-based AutoML systems and the pricing of models generated by cloud-based AutoML systems.

### BACKGROUND

Systems and methods are known for cloud-based services, or the on-line provisioning of computing resources as services. Service providing entities now offer cloud-based AutoML services where artificial intelligence or machine learned models are generated and built by and for end use customers.

Currently, such entities provisioning cloud-based models implement a cost or pricing scheme according to current cloud-based pricing models, e.g., a cloud resource utilization-based pricing model where pricing is based according to the amount of resources being used.

For example, current automated machine learning systems (AutoML systems or services) are cloud-based and the pricing structure of these systems is based on the standard cloud pricing structure, which charges for per unit of compute used by AutoML systems.

In such current cloud-based pricing models, users are allocated compute resources in the cloud, and users are charged based on their usage. As an example, some current AutoML service providers charge for usage services by computation (e.g., number of nodes, duration, memory usage, etc.) and input data volume. However, such pricing does not account for model quality or input data characteristics.

For example, to earn more revenue with current cloud-based pricing structures, it would be necessary to run the AutoML systems for more time and this objective directly conflicts with the objective of AutoML systems, which is to create accurate models and fast.

### SUMMARY

The following summary is merely intended to be exemplary. The summary is not intended to limit the scope of the claims.

According to an aspect, a system and method is provided for a cloud-based service provide to price models generated by cloud-based AutoML systems on the performance enhancement they deliver to the end-user.

According to a further aspect, a system and method is provided for building a pricing model for automated machine learning usage that is in-line with an optimization objective of machine learning systems.

Further aspects include implementing a pricing scheme for pricing a customer's generation and use of cloud-based AutoML and AI models that prices according to the quality of the model and other user-defined metrics —such model quality and user-defined metrics criteria defining the model's utility availed by the end user.

According to an aspect, a system and method implementing a pricing scheme for pricing a customer's generation and use of cloud-based AutoML and AI models that modifies a current cloud-based pricing model according to the quality of the model and other user-defined metrics.

According to one aspect, there is provided a computer-implemented method of managing provision of model prediction services. The method comprises: receiving, by a hardware processor, a user request for providing model prediction services over a network, the user request comprising one or more performance improvement metrics; determining, by the hardware processor, a base model pipeline for the prediction services; determining, by the hardware processor, a first value commensurate with provision of the base model pipeline for the prediction service; determining, by the hardware processor, performance enhancements to the base model pipeline that improve the prediction service performance according to the one or more performance improvement metrics; determining, by the hardware processor, an add-on value commensurate with the improved performance when providing for the prediction service; providing, by the hardware processor, the prediction service including the base model pipeline enhancements; and assessing, by the hardware processor, a charge to the user for receiving the prediction service according to the first value and add-on value.

According to one aspect, there is provided a computer-implemented system for managing provision of model prediction services. The system comprises: a memory storage device for storing a computer-readable program, and at least one processor adapted to run the computer-readable program to configure the at least one processor to: receive a user request for providing model prediction services over a network, the user request comprising one or more performance improvement metrics; determine a base model pipeline for the prediction services; determine a first value commensurate with provision of the base model pipeline for the prediction service; determine performance enhancements to the base model pipeline that improve the prediction service performance according to the one or more performance improvement metrics; and determine an add-on value commensurate with the improved performance when providing for the prediction service; provide the prediction service including the base model pipeline enhancements; and assess a charge to the user for receiving the prediction service according to the first value and add-on value.

In a further aspect, there is provided a computer program product for performing operations. The computer program product includes a storage medium readable by a processing circuit and storing instructions run by the processing circuit for running a method. The method is the same as listed above.

### BRIEF DESCRIPTION OF THE SEVERAL VIEWS OF THE DRAWINGS

The foregoing aspects and other features are explained in the following description, taken in connection with the accompanying drawings, wherein:

FIG. 1 schematically shows an exemplary computer system which is applicable to implement the embodiments for Pay-As-You-Go (PAYG) pricing of cloud-based AutoML model usage according to an embodiment of the present invention;

FIG. 2 shows a method invoked by the AutoML API that further initiates running of real-time pricing model(s) in a PAYG machine learned prediction model pricing scheme according to an embodiment of the invention;

FIG. 3A shows a method for computing the PAYG price by applying a linear model pipeline pricing scheme;

FIG. 3B shows a method for computing the PAYG price by applying an exponential model pipeline pricing scheme;

FIG. 4 depicts an example user interface presenting in tabular form example types of procurable models, their respective procurable model pipelines, and for each model pipeline, a respective performance metric(s) and usage charge (price) to be assessed for model pipeline usage according to an embodiment;

FIG. 5 illustrates a schematic of an example computer or processing system that may implement methods for automatically running real-time pricing model(s) in a PAYG machine learned prediction model pricing scheme according to embodiments of the present invention;

FIG. 6 depicts a cloud computing environment according to an embodiment of the present invention; and

FIG. 7 depicts abstraction model layers according to an embodiment of the present invention.

### DETAILED DESCRIPTION

According to an embodiment, the present disclosure provides for a system and a method for service providers to implement a Pay-As-You-Go (PAYG) automated machine learning (AutoML) prediction system where the end user is charged for model pipeline usage on the basis of performance improvement achieved by the system. As referred to herein, a “pipeline” means the machine learning models produced by the AutoML system which include a sequence of data transformation and modeling steps and for which a price is determined using a “base” model as reference. As used herein, a model architecture pipeline(s) refers to AutoML pipeline(s), AutoML model pipeline(s), or AutoML model(s).

In an embodiment, the performance improvement is determined relative to the performance obtained by a base model which is also a machine learning model or machine learning pipeline (also referred to as a base ML model or base ML model pipeline). For example, the base model price for the given user dataset is identified as a “simple” model whose results can be replicated by the user on any system or on any system of the competitor. The base model is priced using the current cloud resource utilization-based pricing model (i.e., price the base model according to the amount of resources being used). As these results are easily replicable on other clouds, this model is not priced in any other way but by using resource utilization.

In embodiments, the system and method further implements receiving user specified performance metric(s) and the system responsively performs a ranking of AutoML model pipelines based on user specified metric, or combination of metrics (for example: accuracy, prediction time and F1 score).

In an embodiment, the price for each of the ranked AutoML model pipelines is determined based on a “surrogate” model. In such an embodiment, the method performs fitting a surrogate model to the base model price and the maximum price for a model. Then, the pricing increments according to linear differences or fixed percentage differences in the metrics.

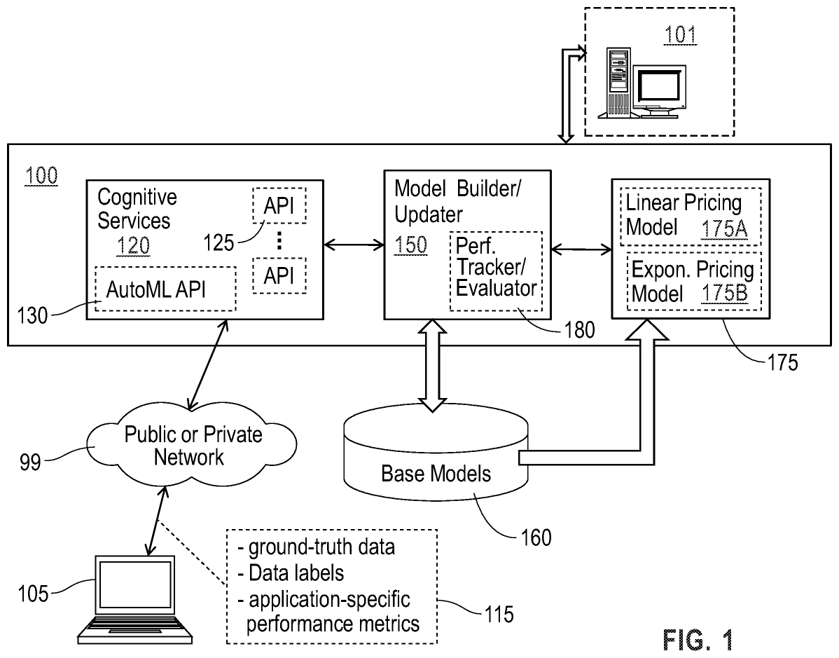

FIG. 1 generally depicts a network-based infrastructure provided by a service provider 101 (or cloud provider) providing a computing and data processing environment 100 within which a “pay as you go” AutoML scheme of the present invention is implemented. As shown in FIG. 1, the infrastructure generally provides cognitive computing services 120, which may be include a set of application program interfaces (APIs) 125 that offer a variety of services, e.g., computer vision, natural language processing (NLP) or any services offered to perform cloud-based predictions. End users 105, such as developers, consume these APIs to use these services to make predictions without having knowledge of ML algorithms or processing pipelines implemented.

As shown in FIG. 1, one cognitive computing service includes AutoML a cloud-based ML or AI service that enables an end user 105 to consume a network based service, e.g., running AutoML system APIs 130 (e.g., AutoML system, a product by International Business Machines Corp.) that enables training/building high-quality custom machine learning models with minimum effort and machine learning expertise. As shown in FIG. 1, such AutoML APIs 130 access a model build component 150 running program instructions and implementing logic for training existing services/models with custom data. For example, a developer end-user can use the AutoML APIs 130 that calls model build component 150 to provide the ability to consume and customize pre-trained or pre-configured “base models” 160 in order to add new AI capabilities via the cloud rather than building/training new custom models. Once trained, these “new” applications or customized ML models can be hosted and available for other users.

In accordance with an aspect of the invention, via the AutoML APIs, the end user 105 provides input training data 115 into the system for use in generating and building customized prediction models. Such training data 115 includes but not limited to: ground-truth data consisting of data that the ML models are to predict, data labels and application-specific performance metrics used to evaluate the built or customized model. Such application-specific performance metrics include utility based metrics the user cares about for evaluating a quality of the customized model. Example utility-based metrics used for evaluating a quality of the customized model includes, but is not limited to: a time (e.g., a lag time or throughput in nanoseconds) it takes the model to generate a prediction, the accuracy of the prediction (e.g., precision, recall, F1 score). In an embodiment, the user can enter a desired run time for solving a time series prediction problem, and a desired time series prediction result (prediction) accuracy. Alternately, the user can specify a run time ratio preference which is a ratio of additional gain accuracy gain over run time, e.g., a 1% higher accuracy per hour, which means one additional hour run time will lead to 1% higher accuracy conditional on the current accuracy.

In an embodiment, the computing and data processing environment 100 provides a service endpoint within which the AutoML system API 130 performs methods to input or retrieve a created dataset or import data into or update a dataset for use in training/customizing one or more models using the model builder component 150. That is, a library of algorithms are available for configuring models to perform: regression, complex multiclass classification, and deep learning. Further methods include: methods to create/delete or deploy a customized model; methods to export a trained model to a user specified storage location; methods implemented to perform on-line predictions, list models and their corresponding pricing, and methods to obtain a model evaluation or list model evaluations.

In an example implementation, an end-user 105 inputs a dataset dependent upon the business use case or application. For example, in a computer vision use case scenario, an example dataset entered by a user or specified at another location for input may include a .csv file with the location and labels for each of multiple training images where a classified image is assigned a single label, or an image is assigned multiple labels. The AutoML API function initiates a training operation using the model builder component 150 to build one or more customized models. Dependent upon the user-specified utility-based metrics, several prediction models may be generated that aim to satisfy one or more of the metrics, e.g., multilayer perceptron (MPL) models, convolution neural network models (CNN) or recurrent neural network models (RNN). When training is complete, a model identifier is returned for each customized model generated.

After training, the AutoML API function initiates a quality evaluation of the model, e.g., by reviewing a time for it to produce a prediction result given a dataset, or by reviewing the model's accuracy, e.g., by evaluating its precision, recall, and F1 score. In embodiments, a combination of user-specified metrics, e.g., time, accuracy, F1 score, or combinations thereof, is used for evaluating the model quality for pricing purposes.

In an embodiment, at the service endpoint, the AutoML API 130 further initiates running of performance tracking methods 180 for evaluating the customized model being made. For example, using a test dataset the performance tracker component 180 receives and evaluates test predictions for a customized model. Once a model is built that achieves performance metrics specified by a user, the updated model is rendered available via an API 130 for subsequent access via user device 105. For example, the newly customized model may be hosted by the cloud service provider or downloaded for use in an application by the end-user.

At the service endpoint, the AutoML API 130 further initiates running of real-time pricing model(s) 175 implementing one or more functions that take input parameters to determine a cost for the end-user who use the infrastructure to train, deploy and/or host custom models and receive the benefit from the ML system.

In one embodiment, a first pricing model(s) 175A determines AutoML model pricing based on model quality using a base model price and a linear pricing model. A second pricing model(s) 175B determines AutoML model pricing based on model quality using a base model pipeline price and an exponential pricing model. Such pricing models 175A, 175B run functions implementing logic to charge the end-user 105 on the basis of performance improvement achieved by the configurable model pipeline relative to a base model pipeline from which it is built. In an embodiment, the performance improvement is determined from user-specified performance metric(s).

In embodiments, the base model pipeline is a simple model whose results can be replicated by the user on any system or on any system of a competitor. Initially, a base model price for the given user dataset can be a fixed price. The base model price for the given user dataset is first identified using any current cloud resource utilization-based pricing model, i.e. price the base model according to the amount of resources being used. This pricing structure is based on resource usage and can include for instance pricing charge based on computation (e.g., number of nodes, number of processing cores, duration, RAM usage, temporary/external storage memory usage, etc.) and input data volume. This is because these results are easily replicable on other clouds, so this model cannot be priced in any other way but by using resource utilization.

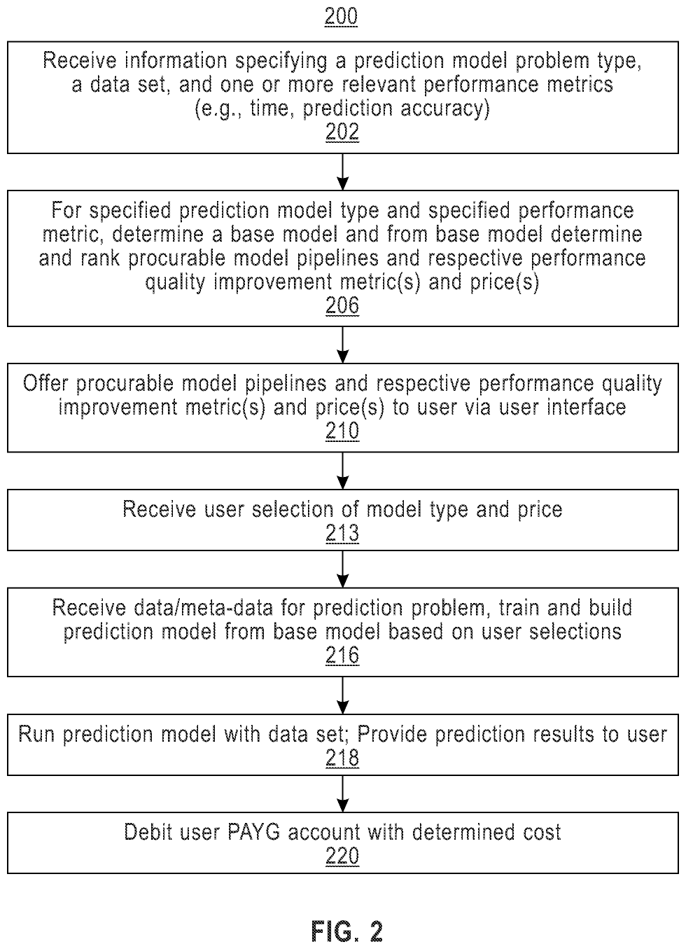

FIG. 2 shows a method 200 run by the AutoML API service that further initiates running (download or cloud deployment) of real-time pricing model(s) in a PAYG machine learned model pricing scheme. At a first step 202, there is depicted a step of receiving information from a remote end user specifying the type of classification or time-series prediction model to be configured for use and/or deployment using the AutoML API. In addition, there may be provided a data set for training the ML model to solve the particular prediction problem, and a specification of one or more relevant performance metrics or model performance quality improvement metric that the user cares about (e.g., time, prediction accuracy, explainability).

Then, continuing to 206, based upon the specified prediction model type and specified performance metric(s), the AutoML method determines a base model pipeline from which to build the requested prediction model with enhanced performance as requested. From this base model, the system further determines all procurable model pipelines that can be built off the base model that can achieve the performance/quality improvement metric(s) as specified using the AutoML program. Each of these individual procurable model pipelines have an associated “Pay as you go” (PAYG) price or additional cost value to be added onto the base model price. Alternatively, or in addition, the potential models can be ranked according to their performance enhancement(s)/achievable metric(s) and the model pipelines valued or priced accordingly.

To price a specific prediction model to offer the end user, at step 206, or at a time even prior to receiving the request, given a base model pipeline for the particular prediction problem to be solved and potential performance enhancement(s)/achievable metric(s), a determination is made to value potential procurable models according to a linear pricing scheme or exponential pricing scheme.

Such linear or exponential pricing schemes for valuing potential pipeline models is an additional value or cost ultimately added-on to a pre-determined or fixed base model pipeline usage cost. In embodiments, the pre-determined base model pipeline is priced as a simple model whose results can be replicated by the user on any system or on any system of a competitor. For example, the base model pipeline is priced using a cloud resource utilization-based pricing model (i.e., price the base model pipeline according to the amount of resources being used). This is because these results are easily replicable on other clouds, so this model cannot be priced in any other way but by using resource utilization.

If an improved prediction model is subject to a linear pricing scheme, the system will invoke methods to compute the PAYG price by applying the linear pricing scheme. The linear pricing scheme invokes methods for identifying the base model pipeline price for the given user dataset (e.g., some fixed price) and performs a ranking of different model pipelines that can be built based on the user specified metric, e.g., run time, prediction accuracy, explainability. Finally, the method specifies a price for ranked pipelines based on a linear model.

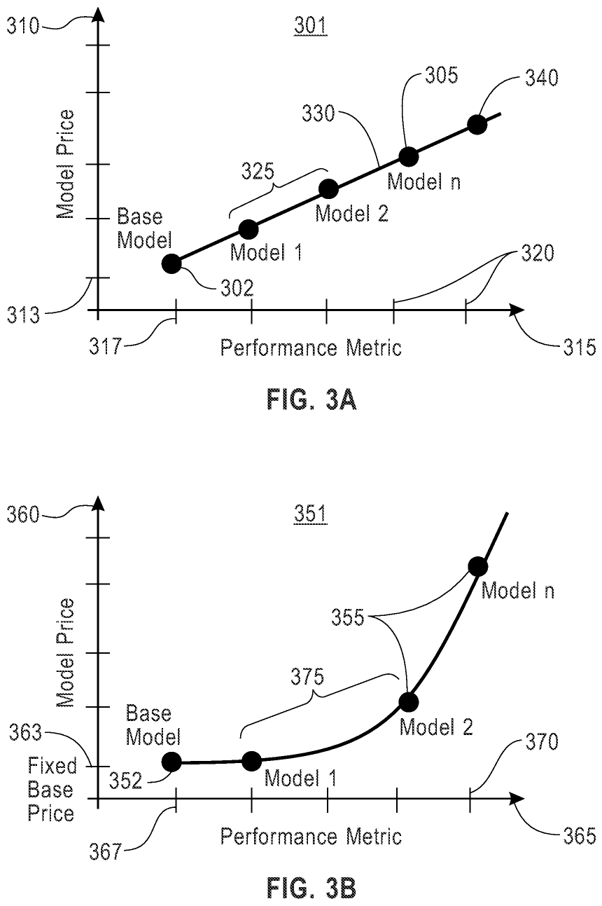

FIG. 3A shows the method for computing the PAYG price by applying the linear pricing scheme in which a linear plot 301 is used to price a procurable model pipeline based on model pricing values 310 along a Y-Axis against achievable performance metrics 315 along the X-Axis. Such performance metrics 315 can include but are not limited to: a run time, a prediction accuracy, an explainability, and/or combinations thereof. Initially, there is shown a base model pipeline pricing value 313 for the initial base model pipeline 302 known to work with the data set type and that is built to solve a particular prediction problem and achieves a particular base performance according to a base performance metric 317. The plot 301 shows additional resulting procurable model pipelines 305 that can be built using the AutoML API for the user to solve a particular prediction problem according to the supplied data set and requested accuracy. Each of these model pipelines are ranked, i.e., priced 310, according to respective corresponding performance metric 320 the respective model pipeline achieves. As can be seen in FIG. 3A, the spacing 325 between any two consecutive model pipelines 305 is linear, thus dictating a linear increase delta in respective resulting PAYG pricing that can be offered to the end user. Such a pricing model 301 can be built by fitting a regression line 330 to the base model price and the maximum price for a “best” performing model, e.g., model 340, with the pricing incremented according to the difference in the metric.

Returning to FIG. 2, at 206, if it is determined that the improved prediction model is not subject to the linear pricing scheme, the method proceeds to compute the PAYG price for procurable model pipelines according to an exponential (or non-linear) pricing model.

FIG. 3B shows the method for computing the PAYG price by applying the exponential pricing scheme. As shown in FIG. 3B, an exponential plot 351 is used to price a procurable model based on model pricing values 360 along a Y-Axis against achievable performance metrics 365 along the X-Axis. Such performance metrics 365 can include but are not limited to: a run time, a prediction accuracy, an explainability, and/or combinations thereof. Initially, there is shown a base model pricing value 363 for the initial base model pipeline 352 known to work with the data set and that is built to solve a particular prediction problem and achieves a particular base performance according to a base performance metric 367. The plot 351 shows additional resulting model pipelines 355 that can be built by the AutoML API for the user to solve a particular prediction problem according to the supplied data set and requested accuracy. Each of these model pipelines are priced 360 according to respective corresponding performance metric 370 the respective model pipeline achieves. As can be seen in FIG. 3B, the spacing 375 between any two consecutive model pipelines 355 is non-linear, e.g., exponential, thus dictating an exponential or fixed percentage hike (%) increase delta in respective resulting PAYG pricing. Such a pricing model 351 can be built by pricing each consecutive next “best” model 355 according to a fixed percentage hike as compared to the pricing of the immediate prior best model.

Returning to FIG. 2, the method proceeds to step 210 where the system presents to an end user device interface, the types of procurable model pipelines that can be trained/built and the respective performance metrics achievable by each model pipeline. In an embodiment, each of the procurable model pipelines may be configured to achieve a combination of performance metrics, e.g., run time+explainability, run time+accuracy, accuracy+explainability, etc. Additionally offered to the user via the user interface device is a respective model pipeline value or cost, i.e., priced according to the linear pricing model of FIG. 3A or exponential pricing model of FIG. 3B.

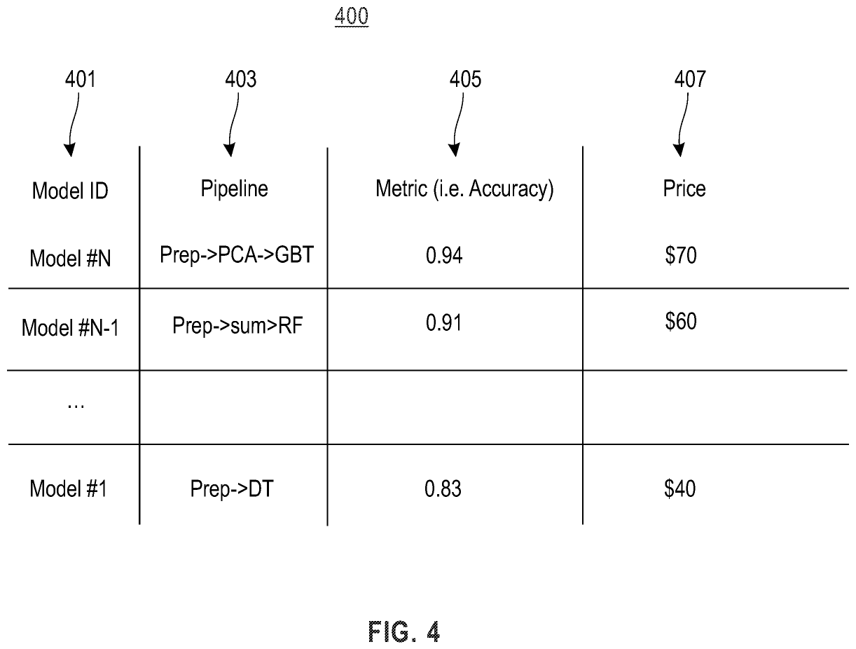

FIG. 4 depicts a user interface 400 presenting in tabular form example types of procurable models, according to their model identifiers 401 (e.g., Model_1, Model_2, . . . , Model_N−1, Model_N) and the respective procurable model pipelines 403 including indications of the actual processing models configured in each model pipeline that can be trained/built, e.g., gradient boost tree (GBT), random forest (RF), decision tree (DT), support vector machine (SVM) and principle component analysis (PCA) (or multivariate statistical analysis), etc. Additionally presented to the user via the user interface for each model pipeline is its respective characterizing quality, i.e., a respective performance metric(s) 405 achievable by each model pipeline. In the example table 400 presented to a user as shown in FIG. 4, each model pipeline is indicated with a respective prediction result accuracy metric between a value of 0 and 1. Each model pipeline may be additionally indicated with a combination of performance metrics achievable, e.g., run time+explainability, run time+accuracy, accuracy+explainability, etc.

In the embodiments herein, one system API used in the AutoML system 100 includes an API for evaluating the quality of a pipeline model's prediction. The performance tracker/evaluator module 180 may implement functions assessing prediction errors for purposes of model quality evaluation. These metrics include but are not limited to one or more of: classification metrics, multilabel ranking metrics, regression metrics and clustering metrics. Types of performance metrics that can be specified include, but are not limited to: Precision_recall_curve, Roc_curve, balanced_accuracy_score, cohen_kappa_score, confusion_matrix, hinge_loss, Matthews_corrcoef, accuracy_score, classification_report, f1_score, fbeta_score, hamming_loss, jaccard_score, log-loss, multilabel_confusion_matrix, precision_recall_fscore_support, precision_score, recall_score, roc_auc_score, zero_one_Joss, average_precision_score, precision_score, recall_score, mean_squared_error, mean_absolute_error, explained_variance_score and r2_score.

Additionally presented to the user via the user interface for each model pipeline is a respective model pipeline value or corresponding PAYG price 407 for implementing (deploying or downloading) the customized model. This corresponding PAYG price 407 is in accordance with a relevant currency (e.g., U.S. dollars) determined according to the linear or exponential pricing scheme.

Although not shown in FIG. 4, it may be the case that the user may be charged a periodic access usage charge, just for use of the hardware, which may be an amount that is less than the charges assessed in current pricing models that assess charge completely based for use of hardware computing resources.

The end user may then select a customized model with the indicated processing that meets the specified quality standards. That is, returning to step 213, FIG. 2, via the user device interface, the user selects a type of model with corresponding PAYG price based on the user interface offerings as shown in table 400 of FIG. 4. The AutoML search program receives the user selection of the model type and prediction accuracy and PAYG price for initiating training and building of the best prediction or classification model using the AutoML model builder given the user-desired performance metrics. If already built, this selected model may then be deployed at the cloud and hosted for the classifying applications, or can be downloaded to the end-user for use in an application.

Otherwise, at 216, FIG. 2, if not already received, the AutoML program receives an upload of the data/meta-data for the user's prediction problem to be solved in the appropriate format, e.g., comma separated values (csv). In an embodiment, the data/meta-data set received from the user is used to train and build the specified prediction model from the base prediction model using the AutoML program, e.g., by invoking the automated machine learning model build operations that grow and enhance the base model pipeline to result in the build of the specified prediction model pipeline to solve a particular prediction problem that achieves the user-requested performance metric(s).

Continuing to step 218, FIG. 2, the AutoML model service program runs the selected prediction model with a new data set to solve the particular user's prediction problem and provides prediction results back to the user within the requested time or within given accuracy specification. During the step 218, for the type of prediction model built, the performance tracker/evaluator module 180 ensures that the one or more user-requested performance metrics are achieved that exceed the base model pipeline performance, and meet the requested performance quality improvement.

Further, at 220, FIG. 2, the user's PAYG account is debited or invoiced based on the cost determined by the model pipeline implemented and customized according to the user performance metric selections That is, after using the built model pipeline, the model user's account is debited according to the cost value for building/using the model pipeline that has been determined according to either the linear PAYG pricing model (FIG. 3A) or exponential PAYG pricing model (FIG. 3B). In an embodiment, the prediction model end user may set up in advance with a cloud-based prediction model service provider or host, a “Pay as you go” account which can include a prepaid plan for the user to consume resources for building and using prediction models with their data sets and in accordance with requested a performance metric(s), e.g., time it takes to deliver prediction results to end user, prediction result accuracy. At 220, FIG. 2, for any model built/used using the AutoML prediction modeling service, the users PAYG account can be automatically debited according to the implemented linear or exponential pricing scheme used to price the model pipeline built to achieve the particular performance metric. Otherwise, the user can be subsequently invoiced at that price according to another conventional cloud-based customer invoicing scheme as known in the art.

In an embodiment, the providers of the PAYG system can further charge to end users a profit margin which is included in a fixed base model usage charge or price according to the base model.

In embodiments, the end user can be additionally optionally charged a periodic access usage charge.

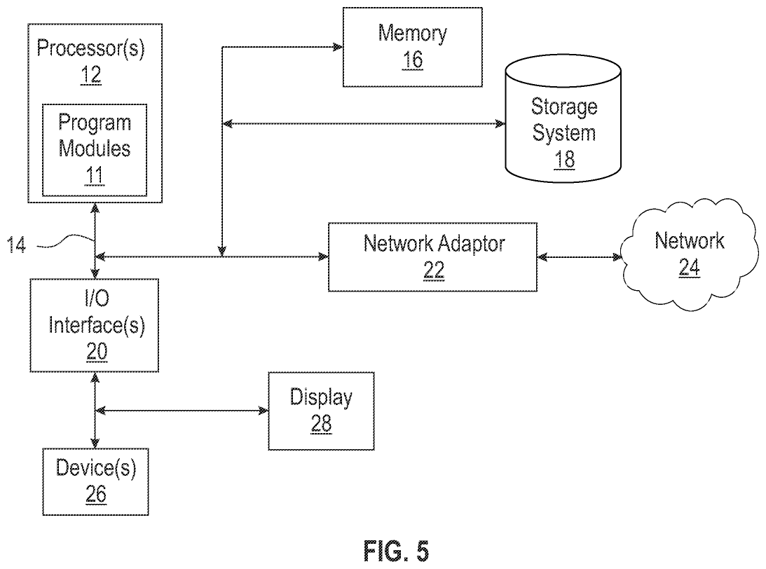

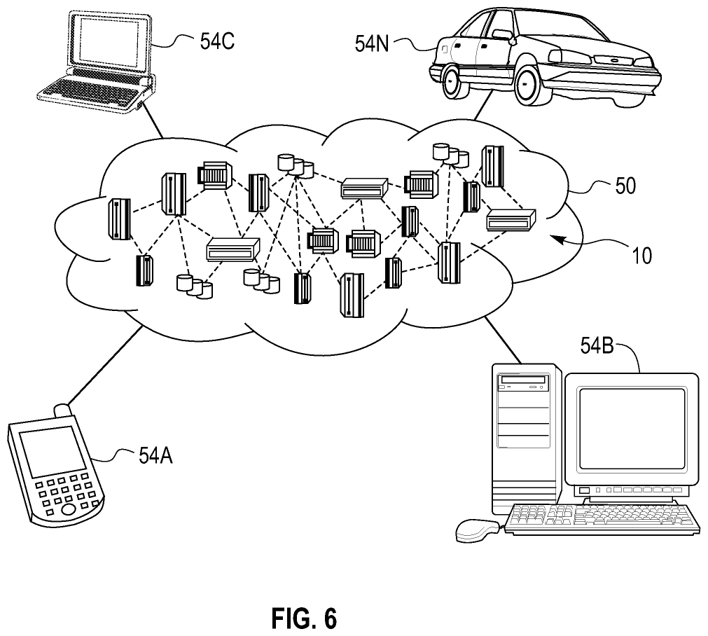

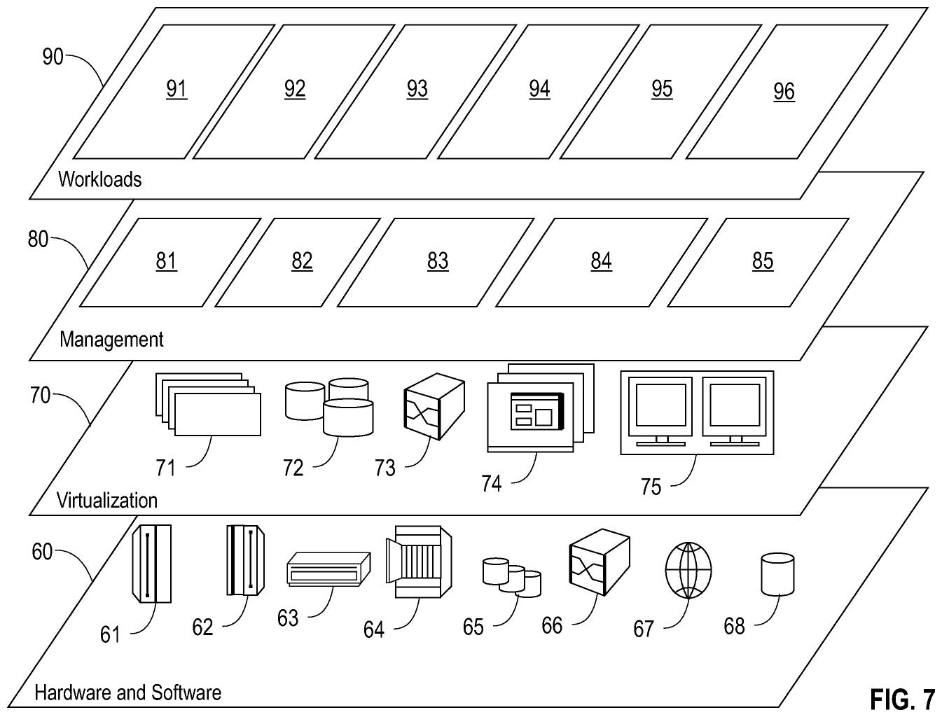

FIG. 5 illustrates an example computing system in accordance with the present invention. It is to be understood that the computer system depicted is only one example of a suitable processing system and is not intended to suggest any limitation as to the scope of use or functionality of embodiments of the present invention. For example, the system shown may be operational with numerous other general-purpose or special-purpose computing system environments or configurations. Examples of well-known computing systems, environments, and/or configurations that may be suitable for use with the system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In some embodiments, the computer system may be described in the general context of computer system executable instructions, embodied as program modules stored in memory 16, being executed by the computer system. Generally, program modules may include routines, programs, objects, components, logic, data structures, and so on that perform particular tasks and/or implement particular input data and/or data types in accordance with the present invention (see e.g., FIGS. 2, 3A-3B).

The components of the computer system may include, but are not limited to, one or more processors or processing units 12, a memory 16, and a bus 14 that operably couples various system components, including memory 16 to processor 12. In some embodiments, the processor 12 may execute one or more modules 11 that are loaded from memory 16, where the program module(s) embody software (program instructions) that cause the processor to perform one or more method embodiments of the present invention. In some embodiments, module 11 may be programmed into the integrated circuits of the processor 12, loaded from memory 16, storage device 18, network 24 and/or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

Memory 16 (sometimes referred to as system memory) can include computer readable media in the form of volatile memory, such as random access memory (RAM), cache memory an/or other forms. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20.

Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing 96 to automatically price prediction model pipelines used in solving user prediction problems within specified performance metrics constraints.

What is claimed is:

1. A computer-implemented method of managing provision of model prediction services comprising:
receiving, by a processor, a user request for providing model prediction services over a network, said user request comprising one or more performance improvement metrics;
determining, by the processor, a base model pipeline for the prediction services;
determining, by the processor, a first value commensurate with provision of said base model pipeline for said prediction service;
determining, by the processor, performance enhancements to said base model pipeline that improve said prediction service performance according to said one or more performance improvement metrics;
determining, by the processor, an add-on value commensurate with the improved performance when providing for said prediction service;
providing, by the processor, the prediction service including the base model pipeline enhancements; and
assessing, by the processor, a charge to the user for receiving said prediction service according to said first value and add-on value.

2. The computer-implemented method of claim 1, further comprising:
using the processor for automatically debiting an account associated with the user the assessed charge for said prediction service.

3. The computer-implemented method of claim 1, wherein said determining performance enhancements to said base model pipeline comprises:
determining, by the processor, the performance improvement relative to the performance obtained by the base model pipeline.

4. The computer-implemented method of claim 1, wherein said determining performance enhancements to said base model pipeline comprises:
determining, by the processor, a plurality of model architecture pipelines, each pipeline characterized according to one or more performance metrics; and
ranking, by the processor, said plurality of model architecture pipelines based on a user specified metric, or combination of performance metrics.

5. The computer-implemented method of claim 1, wherein said add-on value is determined based on linear price increments corresponding to respective one or more model performance metric increments, or is determined based on exponential price increments corresponding to respective one or more model performance metric increments.

6. The computer-implemented method of claim 5, wherein said determining said add-on value based on linear price increments comprises:
fitting, by the processor, a regression line from an initial base model value and a maximum value of a model used to provide said prediction service for said user,
determining, by said processor, one or more performance metrics relating to the provided performance improvement; and
incrementing, by the processor, said add-on value from said initial base model value according to a difference in the performance metric.

7. The computer-implemented method of claim 5, wherein said determining said add-on value based on exponential price increments comprises:
determining, by said processor, one or more performance metrics relating to the provided performance improvement; and
incrementing, by the processor, said add-on value from said initial base model value as a fixed-percentage increase for each successive difference in the performance metric improvement.

8. A computer-implemented system for managing provision of model prediction services, the system comprising:
a memory storage device for storing a computer-readable program, and
at least one processor adapted to run said computer-readable program to configure the at least one processor to:
receive a user request for providing model prediction services over a network, said user request comprising one or more performance improvement metrics;
determine a base model pipeline for the prediction services;
determine a first value commensurate with provision of said base model pipeline for said prediction service;
determine performance enhancements to said base model pipeline that improve said prediction service performance according to said one or more performance improvement metrics; and
determine an add-on value commensurate with the improved performance when providing for said prediction service;
provide the prediction service including the base model pipeline enhancements; and
assess a charge to the user for receiving said prediction service according to said first value and add-on value.

9. The computer-implemented system of claim 8, wherein the at least one processor is further configured to:
automatically debit an account associated with the user the assessed charge for said prediction service.

10. The computer-implemented system of claim 8, wherein to determine a performance enhancement to said base model pipeline, the at least one processor is further configured to:
determine the performance improvement relative to the performance obtained by the base model pipeline.

11. The computer-implemented system of claim 9, wherein to determine said performance enhancements to said base model pipeline, the at least one processor is further configured to:
determine a plurality of model architecture pipelines, each pipeline characterized according to one or more performance metrics; and
rank said plurality of model architecture pipelines based on a user specified metric, or combination of performance metrics.

12. The computer-implemented system of claim 10, wherein said add-on value is determined based on linear price increments corresponding to respective one or more model performance metric increments, or is determined based on exponential price increments corresponding to respective one or more model performance metric increments.

13. The computer-implemented system of claim 10, wherein to determine said add-on value according to a linear price increment, said at least one processor is further configured to:
fit a regression line from an initial base model value and a maximum value of a model used to provide said prediction service for said user,
determine one or more performance metrics relating to the provided performance improvement; and
increment said add-on value from said initial base model value according to a difference in the performance metric.

14. The computer-implemented system of claim 12, wherein to determine said add-on value according to exponential price increments, said at least one processor is further configured to:
determine one or more performance metrics relating to the provided performance improvement; and
increment said add-on value from said initial base model value as a fixed-percentage increase for each successive difference in the performance metric improvement.

15. A computer program product, the computer program product comprising a computer-readable storage medium having a computer-readable program stored therein, wherein the computer-readable program, when executed on a computer including at least one processor, causes the at least one processor to:
receive a user request for providing model prediction services over a network, said user request comprising one or more performance improvement metrics;
determine a base model pipeline for the prediction services;
determine a first value commensurate with provision of said base model pipeline for said prediction service;
determine performance enhancements to said base model pipeline that improve said prediction service performance according to said one or more performance improvement metrics; and
determine an add-on value commensurate with the improved performance when providing for said prediction service;
provide the prediction service including the base model pipeline enhancements; and
assess a charge to the user for receiving said prediction service according to said first value and add-on value.

16. The computer program product of claim 15, wherein the computer readable program further configures at least one processor to:
automatically debit an account associated with the user the assessed charge for said prediction service.

17. The computer program product of claim 15, wherein to determine said performance enhancements to said base model pipeline, the computer readable program further configures at least one processor to:
determine a plurality of model architecture pipelines, each pipeline characterized according to one or more performance metrics; and
rank said plurality of model architecture pipelines based on a user specified metric, or combination of performance metrics.

18. The computer program product of claim 17, wherein said add-on value is determined based on linear price increments corresponding to respective one or more model performance metric increments, or is determined based on exponential price increments corresponding to respective one or more model performance metric increments.

19. The computer program product of claim 15, wherein to determine said add-on value according to a linear price increment, the computer readable program further configures at least one processor to:
fit a regression line from an initial base model value and a maximum value of a model used to provide said prediction service for said user,
determine one or more performance metrics relating to the provided performance improvement; and
increment said add-on value from said initial base model value according to a difference in the performance metric.

20. The computer program product of claim 15, wherein to determine said add-on value according to exponential price increments, the computer readable program further configures at least one processor to:
determine one or more performance metrics relating to the provided performance improvement; and
increment said add-on value from said initial base model value as a fixed-percentage increase for each successive difference in the performance metric improvement.
